(19) United States
(12) Patent Application Publication
(10) Pub. No.: US 2007/0279175 A1
(43) Pub. Date: Dec. 6, 2007

(54) Current sensor

(76) Inventor: Tai-Shan Lin, Longtan Township (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/445,352

(22) Filed: Jun. 1, 2006

(51) Int. Cl. H01F 38/20

(52) U.S. Cl. 336/173

(57) ABSTRACT

The present invention provides a current sensor, that is, an open of a C-type core of the current sensor is capable of fastening a PCB in order to dispose the core on the PCB perpendicularly. The PCB is then elongated to an inner surface of the core so as to firmly support the core and enlarge a welding area for the convenience of welding. A front bending portion of the core is properly opposite to a Hall sensing component, and a plurality of terminals of the Hall sensing component can be bended after welding to facilitate that the Hall sensing component embeds a slot of the PCB. Therefore, the advantages of easy manufacturing and fast and stable assembly is achieved; further that, the open of the C-type core is smaller, and the magnetic flux impedance may be smaller due to the C-type core is closer to the Hall sensing component.

### FIELD OF THE INVENTION

The present invention is related to a current sensor, in particular to a sensor providing an open of a C-type core fastened a PCB directly, and contacting surfaces being welded, continuously a Hall sensing component being bended and embedded in slots of the PCB after welding so as to have a smaller open of the C-type core.

### BACKGROUND OF THE INVENTION

A current sensor is mainly to convert magnetic fields to voltages, and such voltages can be amplified to controllable output voltages by means of electric circuits. With reference to FIG. 1, which is a plane schematic view of a current converter in prior arts. As shown in FIG. 1, the current converter with a flat figure primarily comprises a PCB 1, a C-type core 2, a coil 3, a Hall sensing component 4, and a plurality of terminals 6; wherein the PCB 1 has a plurality of circuits 5, the coil 3 encircles the C-type core 2, two ends 7 of the coil 3 elongate to outside of the PCB 1 for connecting other PCBs, the Hall sensing component 4 and the plurality of circuits 5 are located on a same surface of the PCB 1, the plurality of terminals 6 extend to a circumference of the PCB 1 so as to connect external circuits or ground as well as the two ends 7 of the coil 3, the C-type core 2 is stacked by a plurality of sheet materials, a plurality of slot holes 2a for welding are provided on the C-type core 2, and correspondingly a plurality of welding holes la are disposed on the PCB 1 so as to fasten the C-type core 2 and the PCB 1 by welding.

However the current converter still has several shortcomings as follows:

### 1. For fixing the C-type core 2, the plurality of welding holes la are added so as to increase the manufacturing cost and the manufacturing time.

### 2. Since the C-type core 2 of the current converter lies on the PCB 1, some dead spaces are not easy for welding.

### 3. An adjustment for position may be engaged while in welding so as to achieve a precise welding, doing so results in the inconvenience and the difficulty of welding.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### SUMMARY OF THE INVENTION

Shortcomings in prior arts to be solved are as follows: while manufacturing and assembling a C-type core of a current converter, a plurality of welding holes may be disposed on a PCB additionally for fixing the C-type core. On the other hand, the C-type core lies on the PCB by way of welding, and some dead spaces are not easy for welding so as to result in unstable welding and inconvenient manufacturing.

To figure out the shortcomings may express as follows: using an open of a C-type core of a current sensor to fasten a PCB directly, whereby the PCB is fast manufactured without drilling any welding hole. A contacting welding length of the C-type core and the PCB is longer for stronger support, and welding space is increased to prevent dead space and unstable welding so as to achieve easy manufacturing and fast and stable assembly. The PCB has a slot for a Hall sensing component being embedded therein by means of a plurality of bending portions of a plurality of terminals after the Hall sensing component connecting the PCB via such terminals. Therefore the entire thickness of the Hall sensing component is reduced, and the open of the C-type core is relatively smaller; further that, the magnetic flux impedance may be smaller due to the C-type core is closer to the Hall sensing component after assembling.

### BRIEF DESCRIPTION OF THE DRAWINGS

FIG. 1 is a plane schematic view of a current converter in prior arts;

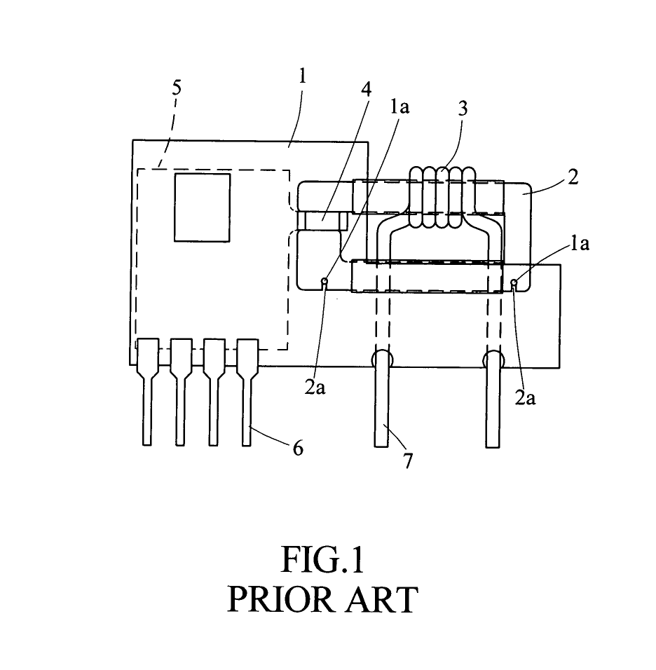

FIG. 2 is a three-dimensional exploded view of a first preferred embodiment of the present invention;

FIG. 3, which is a three-dimensional schematic view of the first preferred embodiment of the present invention;

FIG. 4 is a three-dimensional schematic back view of the first preferred embodiment of the present invention;

FIG. 5 is a three-dimensional schematic back view of a second preferred embodiment of the present invention;

FIG. 6 is a three-dimensional schematic view of welding the Hall sensing component of the second preferred embodiment of the present invention;

FIG. 7 is a three-dimensional view of the second preferred embodiment of the present invention;

FIG. 8 is a vertical sectional view of the second preferred embodiment of the present invention.

### DETAILED DESCRIPTION OF THE PREFERRED EMBODIMENTS

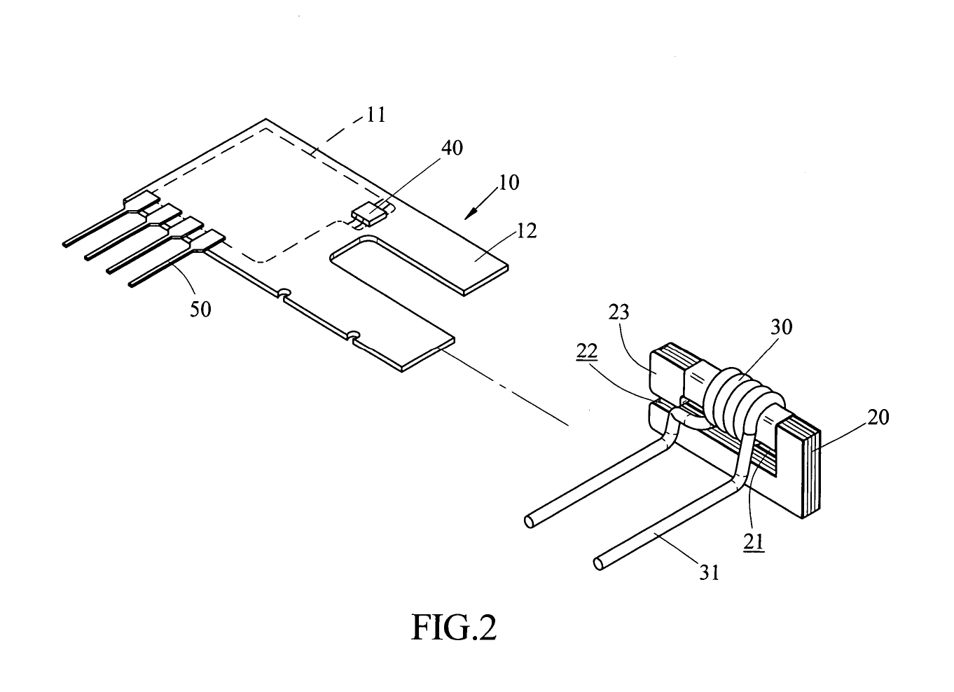

With reference to FIG. 2, which is a three-dimensional exploded view of a first preferred embodiment of the present invention. The current sensor of the present invention mainly comprises a PCB 10, a C-type core 20, a coil 30, a Hall sensing component 40, and a plurality of terminals 50; wherein the PCB 10 has an electric circuit 11 and the plurality of terminals 50 thereon, the terminals 50 elongate to outside along a direction parallel to the PCB 10 from the electric circuit 11, an elongating member 12 of the PCB 10 is protruded toward the C-type core 20, the Hall sensing component 40 is then welded on the electric circuit 11 of the PCB 10; the C-type core 20 opposite to the PCB 10 has an open 22, the open 22 forms an inner slot 21 inward, the C-type core 20 located on a side of the open 22 is a front bending portion 23; the coil 30 encircles the C-type core 20, two ends 31 of the coil 30 extend to outside of the PCB 10 for connecting and assembling other PCBs; the Hall sensing component 40 and the electric circuit 11 are on the same surface of the PCB 10, and the Hall sensing component 40 is firmly welded on the PCB 10.

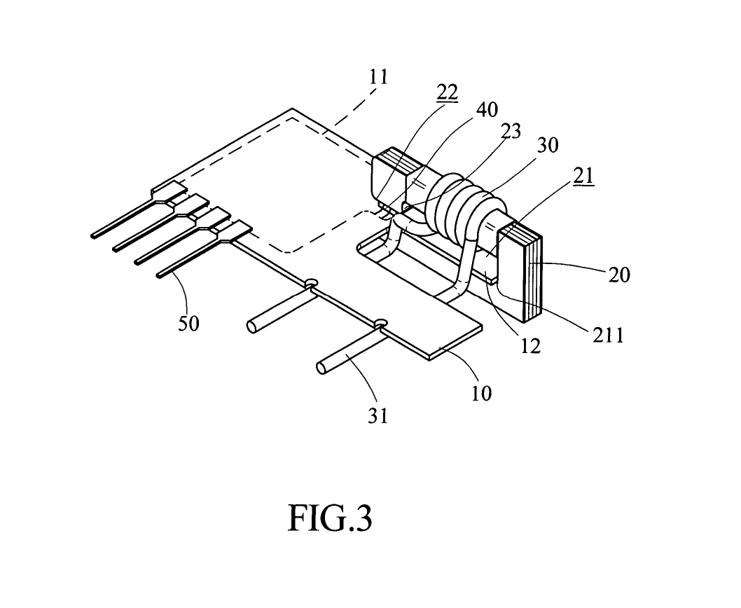

With reference to FIG. 3, which is a three-dimensional schematic view of the first preferred embodiment of the present invention. The plurality of terminals 50 extend to a circumference of the PCB 10 so as to connect circuits as well as the two ends 31 of the coil 30, the C-type core 20 is stacked by a plurality of sheet materials, the inner slot 21, the open 22, and the front bending portion 23 on the open 22 of the C-type core are formed therein, the elongating member 12 is protruded on the C-type core of the PCB 10 and extended into a bottom portion of the inner slot 21 of the C-type core 20.

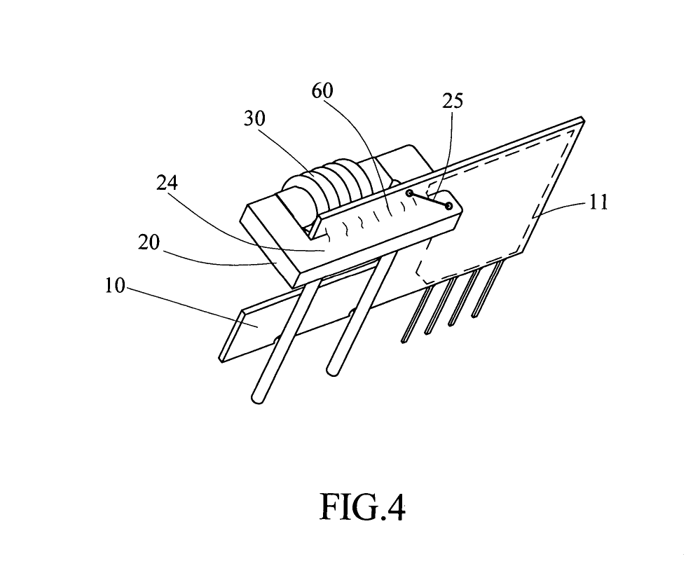

Referring to FIG. 3 and FIG. 4, wherein FIG. 4 is a three-dimensional schematic back view of the first preferred embodiment of the present invention. In the sequence of assembling, the electric circuit 11 of the PCN 10 is organized first. Due to the Hall sensing component 40 and the electric circuit 11 are on the same surface of the PCB 10, the Hall sensing component 40 and the electric circuit 11 are electrically connected each other. The terminals 50 elongate to the PCB for electric connection as well. The coil 30 encircles the C-type core 20, and the open 22 of the C-type core 20 is embedded on the elongating member 12 of the PCB 10; hence a bottom surface 211 of the inner slot 21 of the C-type core is stuck on a back surface of the PCB 10, and it makes that the C-type core 20 perpendicularly embeds to the horizontal PCB 10. The back surface 13 of the PCB 10 and a side wall 24 of the C-type core 20 are welded together, as shown in FIG. 4. The front bending portion 23 of the C-type core is then properly opposite to the Hall sensing component 40, as shown in FIG. 3. Doing so finishes a welding portion 60. The welding portion 60 features that having a larger area for easy welding, and the effect of the welding is stable so as to achieve a high manufacturing yields. Further, the C-type core 20 is firmly welded to the PCB 10 by means of a wire 25.

According to the structure aforesaid, which has the features of fast manufacturing, stable welding, high manufacturing yields, and low cost.

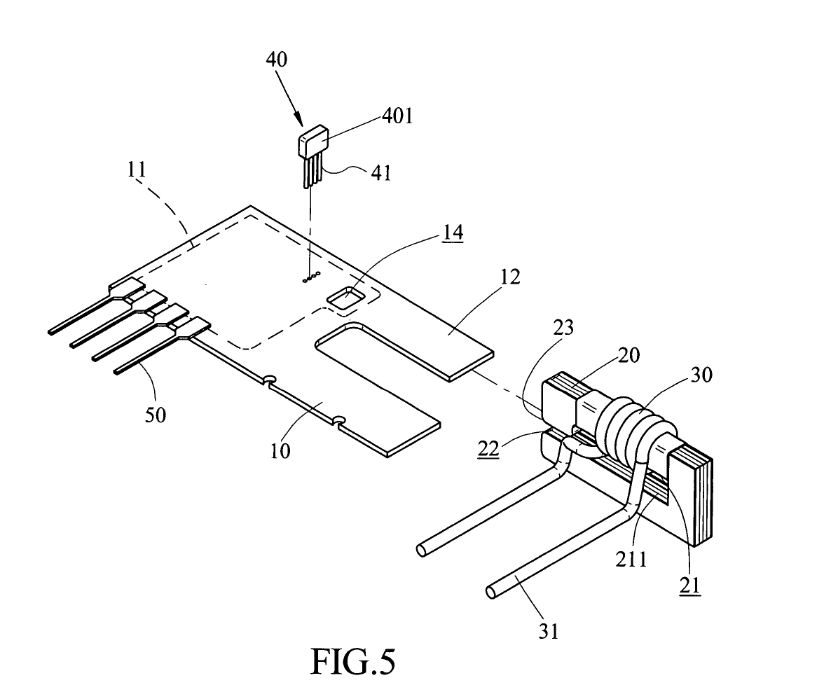

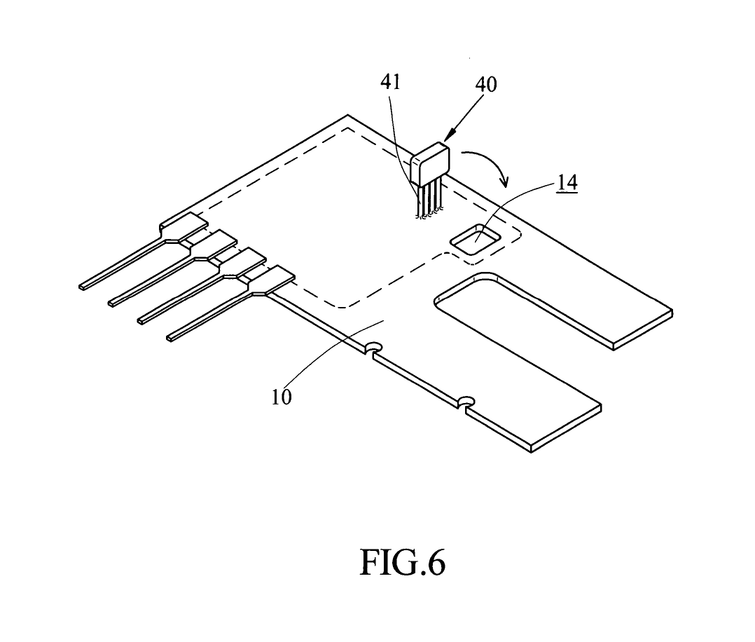

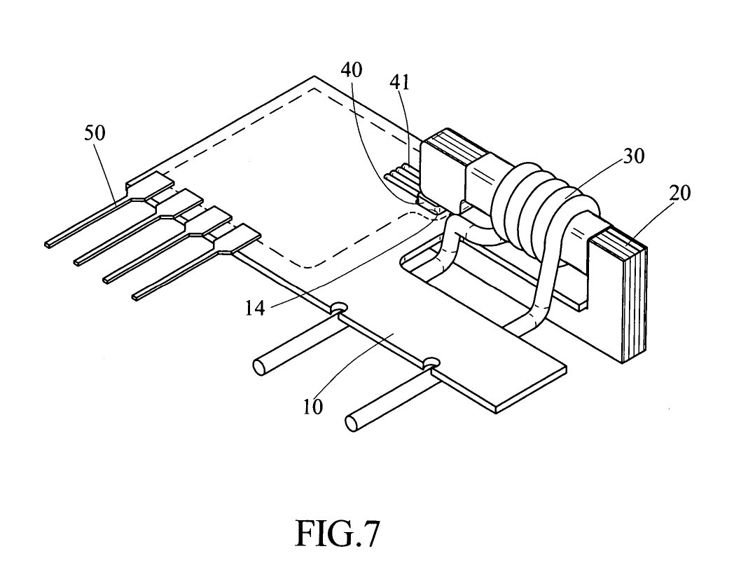

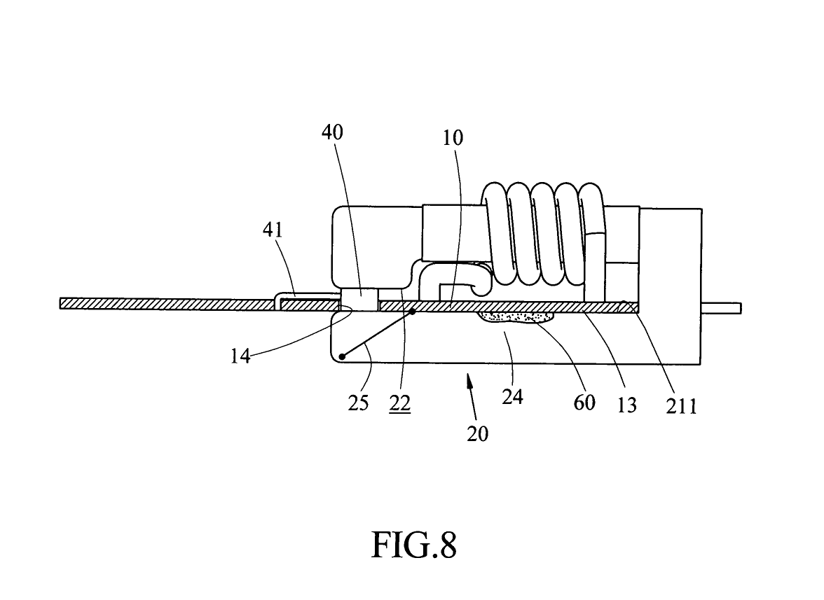

With reference to FIG. 5 to FIG. 8, which are a three-dimensional schematic back view of a second preferred embodiment of the present invention, a three-dimensional schematic view of welding the Hall sensing component of the second preferred embodiment of the present invention, a three-dimensional view of the second preferred embodiment of the present invention, and a vertical sectional view of the second preferred embodiment of the present invention. The PCB 10 has a slot 14 thereon, the slot 14 is located where the Hall sensing component 40 sticks on the PCB 10, as shown in FIG. 5. Such that, the Hall sensing component 40 directly and perpendicularly is welded on the PCB 10 by means of the plurality of terminals 41, as shown in FIG. 6. And the plurality of terminals 41 are bended so as to let the Hall sensing component 40 be embedded in the slot 14, as shown in FIG. 7. Hence, according to the assembled position of the Hall sensing component 40, the thickness of the PCB 10 is reduced. Continuously the entire thickness is relatively smaller, as shown in FIG. 8. The open 22 of the C-type core 20 has a smaller gap in order to make the C-type core 20 be closer to the Hall sensing component 40. So that magnetic flux impedance may be smaller.

The Hall sensing component 40 comprises a body 401 and a plurality of terminals 41; wherein a side of the Hall sensing component 40 has the plurality of terminals 41 protruding outward, or, both sides of the Hall sensing component 40 correspondingly have the plurality of terminals 41 protruding outward, as shown in FIG. 2.

Follows express the improvements of the present invention:

### 1. The present invention may not drilling any welding hole and fast assemble the core; on the other hand, the core is quickly welded with stable welding so as to achieve a high manufacturing yields.

2. The present invention mainly uses that the front bending portion is properly opposite to the Hall sensing component while the C-type core embedding in the PCB, and a larger welding space is between the core and the PCB so as to have an easy and stable welding. Further that, having no welding holes greatly increases the speed of manufacturing to promote manufacturing yields.
3. The Hall sensing component of the present invention may install in the slot of the PCB in order to diminish the entire thickness, therefore the open of the C-type core is reduced either, and the magnetic flux impedance may be smaller since the C-type core is closer to the Hall sensing component.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A current sensor, comprising:
a PCB having an elongating member protruding outward, and a Hall sensing component being welded thereon;
a C-type core having an open, an inner slot, and a front bending portion, the open being embedded in the elongating member of the PCB, the C-type core being perpendicularly embedded in the PCB, the inner slot of the C-type core being stuck on a back surface of the PCB, where a sticking position of the inner slot and the back surface is welded to form a large area welding portion so as to let the front bending portion and the open of the C-type core be properly opposite to the Hall sensing component.

2. The current sensor according to claim 1, wherein the C-type core is firmly welded to the PCB by means of a wire.

3. The current sensor according to claim 1, wherein the PCB has a slot, the Hall sensing component comprises a body and a plurality of terminals, the body is embedded in the slot of the PCB, the plurality of terminals protruding outward are on a same side of the body, each terminal is bended and welded in the PCB, the front bending portion of the C-type core is corresponding the Hall sensing component, the C-type core is welded on the PCB.

4. The current sensor according to claim 3, wherein a side of the body of the Hall sensing component has the plurality of terminals protruding outward.

5. The current sensor according to claim 3, wherein both sides of the Hall sensing component correspondingly have the plurality of terminals protruding outward.
